(19) United States
(12) Patent Application Publication
(10) Pub. No.: US 2024/0177911 A1
(43) Pub. Date: May 30, 2024

(54) PHOTOSENSITIVE CONDUCTIVE PASTE, METHOD FOR PRODUCING MULTILAYER ELECTRONIC COMPONENT, AND MULTILAYER ELECTRONIC COMPONENT

(71) Applicant: Murata Manufacturing Co., Ltd., Kyoto-fu (JP)

(72) Inventor: Kenta KONDO, Nagaokakyo-shi (JP)

(73) Assignee: Murata Manufacturing Co., Ltd., Kyoto-fu (JP)

(21) Appl. No.: 18/516,402

(22) Filed: Nov. 21, 2023

(30) Foreign Application Priority Data
Nov. 24, 2022 (JP) 2022-187698

(51) Int. Cl. H01F 17/00; B22F 1/05; B22F 1/107; B22F 1/16; B22F 3/10; B22F 7/04; C03C 3/064; C03C 3/118; H01F 1/12; H01F 41/00

(52) U.S. Cl. CPC H01F 17/0013; B22F 1/05; B22F 1/107; B22F 1/16; B22F 3/10; B22F 7/04; C03C 3/064; C03C 3/118; H01F 1/12; H01F 41/00; B22F 2301/255; B22F 2304/10; B22F 2998/10

(57) ABSTRACT

A photosensitive conductive paste includes a conductive powder, an alkali-soluble polymer, a photosensitive monomer, a photopolymerization initiator, a dispersant, and a solvent. The conductive powder is covered with a glass having a glass softening point (Ts) of 800° C. or lower.

### CROSS-REFERENCE TO RELATED APPLICATION

This application claims benefit of priority to Japanese Patent Application No. 2022-187698, filed Nov. 24, 2022, the entire content of which is incorporated herein by reference.

### BACKGROUND

### Technical Field

The present disclosure relates to a photosensitive conductive paste, a method for producing a multilayer electronic component, and a multilayer electronic component.

### Background Art

In recent years, multilayer electronic components such as multilayer ceramic circuit boards have been produced by forming an inner electrode using a photosensitive conductive paste. As a result of patterning followed by firing of the photosensitive conductive paste, a conductive powder contained in the photosensitive conductive paste is sintered, thereby forming the inner electrode. Photosensitive conductive pastes for use in multilayer electronic components are disclosed in, for example, Japanese Unexamined Patent Application Publication No. 2002-169274 and Japanese Unexamined Patent Application Publication No. 2007-18884.

Japanese Unexamined Patent Application Publication No. 2002-169274 discloses a photosensitive conductive paste containing, as main components, 40 to 80 wt % of a conductive powder, 3 to 20 wt % of a photopolymerizable compound, 10 wt % or less of a photopolymerization initiator, and 0.3 to 2.5 wt % of one or more non-conductive metal oxides. The non-conductive metal oxides are generally referred to as “commonly-used materials” (note that the common-used material is a non-conductive metal oxide material which is commonly used (i.e. shared) in an inner electrode and an insulating material on which the inner electrode is provided). Japanese Unexamined Patent Application Publication No. 2002-169274 describes that the shrinkage of the inner electrode during firing can be reduced because the commonly-used materials are contained.

Japanese Unexamined Patent Application Publication No. 2007-18884 discloses a photosensitive conductive paste containing a first conductive powder having an average particle diameter of 5 μm or less and obtained by an atomization method and a second conductive powder having an average particle diameter of 0.2 to 2.0 μm and obtained by a wet reduction method at a mass ratio of 20/80≤ (first conductive powder/second conductive powder)≤ 80/20. Japanese Unexamined Patent Application Publication No. 2007-18884 describes that the shrinkage percentage of the inner electrode during firing can be reduced because the first conductive powder having a relatively large average particle diameter is contained.

### SUMMARY

For the photosensitive conductive paste disclosed in Japanese Unexamined Patent Application Publication No. 2002-169274, the shrinkage percentage of the inner electrode during firing is reduced, but the electrical resistance of the inner electrode after firing is increased in some cases because the commonly-used materials that are non-conductive metal oxides are contained. Furthermore, since the amount of powdery components is increased because of the commonly-used materials contained, light scattering due to the powdery components increases at the time of photolithographic patterning. As a result, the resolution is sometimes decreased as compared to the case where the commonly-used materials are not contained.

For the photosensitive conductive paste disclosed in Japanese Unexamined Patent Application Publication No. 2007-18884, the shrinkage percentage of the inner electrode during firing is reduced, but the surface area of the conductive powder may be increased because the second conductive powder having a relatively small average particle diameter is contained. Therefore, light scattering on the surface of the conductive powder increases at the time of photolithographic patterning, which sometimes decreases the resolution.

Accordingly, it the present disclosure provides a photosensitive conductive paste that can reduce the shrinkage percentage of the inner electrode during firing, can improve the resolution at the time of photolithographic patterning, and can reduce the electrical resistance of the inner electrode after firing, a method for producing a multilayer electronic component, and a multilayer electronic component.

A photosensitive conductive paste according to an aspect of the present disclosure includes a conductive powder, an alkali-soluble polymer, a photosensitive monomer, a photopolymerization initiator, a dispersant, and a solvent. The conductive powder is covered with a glass having a glass softening point (Ts) of 800° C. or lower.

According to the above aspect, since the commonly-used materials are not contained, the amount of powdery components can be decreased as compared with known photosensitive conductive pastes, which can improve the resolution at the time of photolithographic patterning. Furthermore, since the conductive powder is covered with the glass, the sintering of the conductive powder is suppressed until the firing temperature reaches the glass softening point of the glass. Therefore, the shrinkage percentage of the inner electrode during firing can be reduced. Moreover, when the firing temperature exceeds the glass softening point, the sintering of the conductive powder is promoted by liquid-phase sintering. Therefore, the electrical resistance of the inner electrode after firing can be reduced as compared with the related art. Herein, the liquid-phase sintering refers to a sintering mechanism in which a viscous liquid is present at a sintering temperature, and is a phenomenon in which the liquid wets solid particles at the sintering temperature to promote sintering.

The photosensitive conductive paste according to an aspect of the present disclosure can reduce the shrinkage percentage of the inner electrode during firing, can improve the resolution at the time of photolithographic patterning, and can reduce the electrical resistance of the inner electrode after firing.

### BRIEF DESCRIPTION OF THE DRAWINGS

FIG. 1 is a perspective view schematically illustrating a multilayer electronic component;

FIG. 2 is an exploded perspective view schematically illustrating the multilayer electronic component;

FIG. 3 is a sectional view schematically illustrating a photosensitive conductive paste; and

FIG. 4 is a diagram for describing an effect of suppressing delamination and reducing the electrical resistance of an inner electrode.

### DETAILED DESCRIPTION

Hereafter, a photosensitive conductive paste, a method for producing a multilayer electronic component, and a multilayer electronic component according to aspects of the present disclosure will be described in detail with reference to embodiments illustrated in the drawings. Some of the drawings are schematic and sometimes do not reflect actual dimensions and ratios.

### Overall Configuration of Multilayer Electronic Component

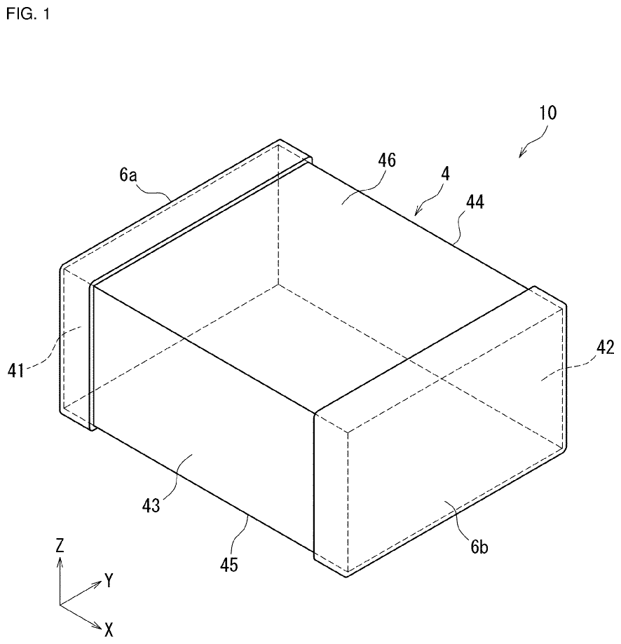

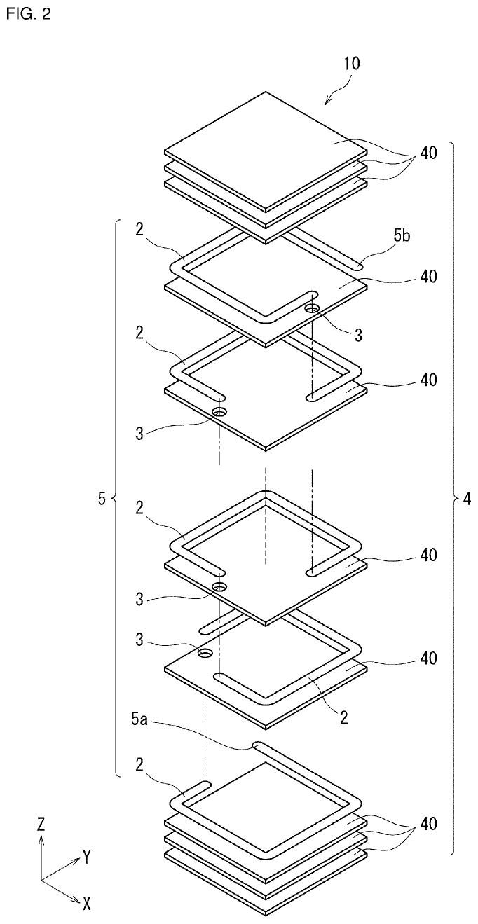

FIG. 1 is a perspective view schematically illustrating a multilayer electronic component. FIG. 2 is an exploded perspective view schematically illustrating the multilayer electronic component. In FIG. 1, the body is illustrated in a transparent manner for easy understanding of the structure, but may be translucent or opaque. In FIG. 1, the coil is not illustrated for easy understanding of the structure. In FIG. 2, the outer electrodes are not illustrated for the sake of clarity.

Hereafter, a multilayer coil component will be described as an example of the multilayer electronic component. However, the multilayer electronic component of the present disclosure is not limited to the multilayer coil component and can be applied to various multilayer electronic components such as a multilayer capacitor component and a multilayer LC composite component.

As illustrated in FIGS. 1 and 2, a multilayer electronic component 10 includes a body 4, a coil 5 disposed in the body 4, and a first outer electrode 6a and a second outer electrode 6b disposed on the body 4. The coil 5 corresponds to an “inner electrode” described in the appended claims.

The shape of the body 4 is not particularly limited, but is a substantially rectangular parallelepiped shape in this embodiment. The body 4 has, as outer surfaces, a first end surface 41, a second end surface 42 opposed to the first end surface 41, a first side surface 43 connecting the first end surface 41 and the second end surface 42, a second side surface 44 opposed to the first side surface 43, a bottom surface 45 connecting the first end surface 41, the second end surface 42, the first side surface 43, and the second side surface 44, and a top surface 46 opposed to the bottom surface 45 and connected to the first end surface 41, the second end surface 42, the first side surface 43, and the second side surface 44. A direction from the first end surface 41 toward the second end surface 42 is defined as an X direction, a direction from the first side surface 43 toward the second side surface 44 is defined as a Y direction, and a direction from the bottom surface 45 toward the top surface 46 is defined as a Z direction. In this specification, the Z direction may be referred to as an upper side.

The body 4 is formed by stacking a plurality of insulating layers 40. The insulating material for the insulating layers 40 is not particularly limited, but includes, for example, borosilicate glass and an inorganic filler. Examples of the inorganic filler include a glass powder and a ceramic aggregate such as alumina. The stacking direction of the insulating layers 40 is parallel to the Z direction. That is, the insulating layers 40 are layers extending in the XY plane. In an insulating layer 40 located between adjacent coil wiring lines 2 of a plurality of coil wiring lines 2 described later, a via hole 3 is provided at a position where the adjacent coil wiring lines 2 are connected. The via hole 3 extends through the insulating layer 40 in the thickness direction (Z direction). The term “parallel” in the present application is not limited to a strict parallel relationship, and also includes a substantially parallel relationship in consideration of a practical variation range. In the body 4, the interfaces between the plurality of insulating layers 40 may be unclear because of firing or the like.

The first outer electrode 6a and the second outer electrode 6b are formed of, for example, a conductive material such as Ag, Cu, Au, or an alloy containing any of these materials as a main component. In this embodiment, the first outer electrode 6a is continuously disposed on the entire first end surface 41 of the body 4, an end portion of the first side surface 43 on the first end surface 41 side, an end portion of the second side surface 44 on the first end surface 41 side, an end portion of the bottom surface 45 on the first end surface 41 side, and an end portion of the top surface 46 on the first end surface 41 side. The second outer electrode 6b is continuously disposed on the entire surface of the second end surface 42 of the body 4, an end portion of the first side surface 43 on the second end surface 42 side, an end portion of the second side surface 44 on the second end surface 42 side, an end portion of the bottom surface 45 on the second end surface 42 side, and an end portion of the top surface 46 on the second end surface 42 side. In short, each of the first outer electrode 6a and the second outer electrode 6b is an electrode with five faces. Alternatively, the first outer electrode 6a may be, for example, an L-shaped electrode continuously disposed on a portion of the first end surface 41 and a portion of the bottom surface 45. Similarly, the second outer electrode 6b may be, for example, an L-shaped electrode continuously disposed on a portion of the second end surface 42 and a portion of the bottom surface 45.

The coil 5 is, for example, a sintered body of a photosensitive conductive paste containing a conductive powder of Ag, Cu, or the like. The coil 5 is helically wound in the stacking direction of the insulating layers 40. The coil 5 has a first end 5a exposed from the first end surface 41 of the body 4 and connected to the first outer electrode 6a. The coil 5 has a second end 5b exposed from the second end surface 42 of the body 4 and connected to the second outer electrode 6b.

The coil 5 is formed in a rectangular shape when viewed in the axial direction, but the shape is not limited to the rectangular shape. The shape of the coil 5 may be, for example, a circle, an ellipse, a rectangle, or another polygon. The axial direction of the coil 5 is parallel to the Z direction, and the coil 5 is wound in the axial direction. The axis of the coil 5 means a central axis of the helical shape of the coil 5.

The coil 5 includes a plurality of coil wiring lines 2 stacked in the axial direction and via wiring lines (not illustrated) extending in the axial direction and each connecting coil wiring lines 2 adjacent to each other in the axial direction. The plurality of coil wiring lines 2 are each wound along a plane, arranged in the axial direction, and electrically connected in series to constitute a helix.

Each of the coil wiring lines 2 is formed by being wound on a main surface (XY plane) of the insulating layer 40 orthogonal to the axial direction. The number of turns of the coil wiring line 2 is less than one, but may be one or more. The via wiring line is provided in the via hole 3 of the insulating layer 40 and extends through the insulating layer 40 in the thickness direction (Z direction). Coil wiring lines 2 adjacent to each other in the stacking direction are electrically connected in series with the via wiring line interposed therebetween.

In such a multilayer electronic component 10, a plurality of insulating layers 40 and a plurality of patterned layers of the photosensitive conductive paste are alternately stacked, and each of the plurality of insulating layers 40 and each of the plurality of patterned layers of the photosensitive conductive paste are sintered. As a result, the body 4 is formed from the plurality of insulating layers 40, and the coil 5 is formed from the plurality of patterned layers of the photosensitive conductive paste.

### Detailed Configuration of Photosensitive Conductive Paste

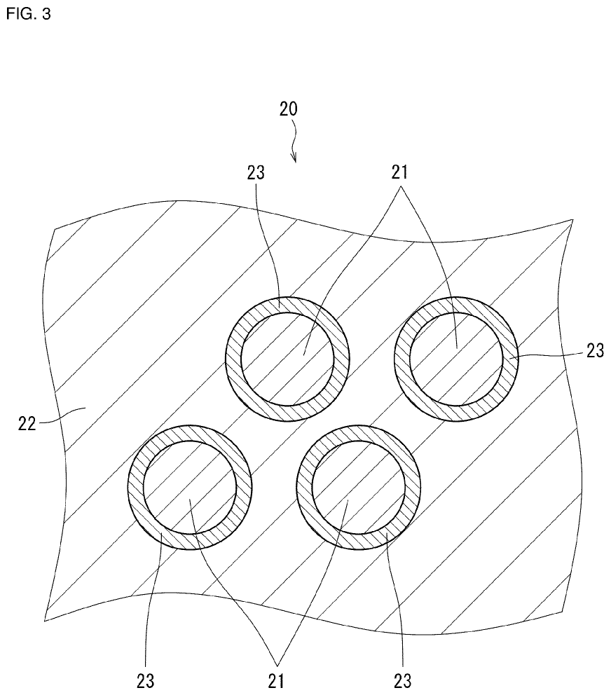

Next, the detailed configuration of the photosensitive conductive paste used for forming the coil 5 will be described. FIG. 3 is a sectional view schematically illustrating the photosensitive conductive paste. Hereafter, a photosensitive conductive paste used for forming the coil 5 of the multilayer electronic component 10, which is a multilayer coil component, will be described. The photosensitive conductive paste of the present disclosure is not limited thereto, and can be used for forming inner electrodes of various multilayer electronic components such as a multilayer capacitor component and a multilayer LC composite component. For example, in the case of multilayer capacitor components, the photosensitive conductive paste of the present disclosure can be used for forming a capacitor electrode.

As illustrated in FIG. 3, a photosensitive conductive paste 20 includes a conductive powder 21, a photosensitive organic component 22, and a dispersant (not illustrated). Specifically, the conductive powder 21 and the dispersant are contained in the photosensitive organic component 22. The conductive powder 21 is covered with a glass 23 having a glass softening point (Ts) of 800° C. or lower.

The conductive powder 21 is sintered during firing, and the resulting sintered body serves as a conductor of the coil 5. The type of the conductive powder 21 is not particularly limited, but is preferably an Ag powder or a Cu powder to reduce the electrical resistance of the coil 5 to be formed. The content of the conductive powder 21 covered with the glass 23 relative to the photosensitive conductive paste 20 is preferably 65 wt % or more and 90 wt % or less (i.e., from 65 wt % to 90 wt %). From the viewpoint of suppressing the shrinkage of the photosensitive conductive paste 20 during firing, the content of the conductive powder 21 covered with the glass 23 relative to the photosensitive conductive paste 20 is more preferably 70 wt % or more and 85 wt % or less (i.e., from 70 wt % to 85 wt %).

The average particle diameter D50 (median size) of the conductive powder 21 is not particularly limited, but is preferably 1.0 μm or more and 5.0 μm or less (i.e., from 1.0 μm to 5.0 μm) from the viewpoint of forming a fine pattern of the coil 5. In the present specification, the average particle diameter D50 is a value measured with a laser diffraction particle size analyzer (MT3000 manufactured by MicrotracBEL Corp.).

The conductive powder 21 is preferably an atomized Ag powder. In this case, the crystallite diameter of the conductive powder 21 is larger than that in the case of using an Ag powder obtained by a wet reduction method, which can decrease the amount of organic impurities. This can reduce the electrical resistance of the coil 5 to be formed. The average particle diameter D50 of the atomized Ag powder is preferably 1.0 μm or more and 5.0 μm or less (i.e., from 1.0 μm to 5.0 μm). Thus, a fine pattern of the coil 5 can be formed.

The glass 23 suppresses the sintering of the conductive powder 21 in a region of a firing temperature up to the glass softening point (Ts) of the glass 23. The glass 23 promotes the sintering of the conductive powder 21 by causing a liquid-phase sintering phenomenon in a region of a firing temperature exceeding the glass softening point (Ts) of the glass 23. The type of the glass 23 is not particularly limited as long as the glass softening point (Ts) is 800° C. or lower. The glass 23 is, for example, a SiO₂—K₂O—B₂O₃-based glass containing SiO₂, B₂O₃, and K₂O at a predetermined ratio. The content of the glass 23 is preferably 1.0 wt % or more and more preferably 5.0 wt % or more relative to the conductive powder 21. The content of the glass 23 is preferably 20 wt % or less and more preferably 10 wt % or less relative to the conductive powder 21.

The glass 23 preferably completely covers the conductive powder 21 (i.e., a coverage of 100%), but does not necessarily completely cover the conductive powder 21. The coverage of the glass 23 relative to the surface area of the conductive powder 21 is preferably 1.0% or more and more preferably 50% or more. This makes it possible to, with more certainty, obtain an effect of suppressing the shrinkage of the inner electrode during firing and an effect of reducing the electrical resistance of the coil 5. The coverage can be measured by, for example, observing a section of the photosensitive conductive paste 20 with an electron microscope.

The photosensitive conductive paste 20 may contain a metal resinate. The resinate is a metal resinate containing a metal having a melting point higher than that of the conductive powder 21. Examples of the metal contained in the metal resinate include Rh, Ni, Cu, Mn, and Zr. Examples of such a metal resinate include metal octylates, metal naphthenates, metal 2-ethylhexanoates, metal sulfonates, metal mercaptides, and alkoxy metal compounds.

The photosensitive organic component 22 contains an alkali-soluble polymer, a photosensitive monomer, a photopolymerization initiator, and a solvent. The content of the photosensitive organic component 22 is preferably 10 wt % or more and more preferably 15 wt % or more relative to the photosensitive conductive paste 20. The content of the photosensitive organic component 22 is preferably 30 wt % or less and more preferably 20 wt % or less relative to the photosensitive conductive paste 20.

The alkali-soluble polymer is solubilized by being neutralized with a basic compound. The alkali-soluble polymer is removed together with an uncured photopolymerizable monomer, the conductive powder 21, and the like, for example, during a development process using an alkaline developer. On the other hand, when the photopolymerizable monomer is polymerized by active energy rays, the alkali-soluble polymer present near the photopolymerizable monomer forms a film together with the polymerized product of the photopolymerizable monomer to constitute, for example, a part of the inner electrode pattern. Thus, the adhesion of the inner electrode pattern to the insulating layer can be further improved. The content of the alkali-soluble polymer is preferably 10 wt % or more and more preferably 20 wt % or more relative to the photosensitive organic component 22. The content of the alkali-soluble polymer is preferably 50 wt % or less and more preferably 60 wt % or less relative to the photosensitive organic component 22.

The alkali-soluble polymer has at least one acid group at the side chain. A typical example of the acid group is a carboxy group. The alkali-soluble polymer includes, as a main chain, a polymer chain having, for example, at least one of a carbon-carbon bond, an ether bond, a urea bond, an ester bond, and a urethane bond. From the viewpoint of transparency, the main chain of the alkali-soluble polymer may include a polymer chain having a carbon-carbon bond.

An alkali-soluble polymer having at least one carboxy group at the side chain and including a polymer chain having a carbon-carbon bond as a main chain is obtained, for example, by copolymerization of an unsaturated carboxylic acid and an ethylenically unsaturated compound. A typical example of the alkali-soluble polymer is a carboxy group-containing acrylic polymer.

Examples of the unsaturated carboxylic acid include acrylic acid, methacrylic acid, crotonic acid, maleic acid, fumaric acid, itaconic acid, and vinyl acetate, and dimers and anhydrides of the foregoing.

Examples of the ethylenically unsaturated compound include acrylates such as methyl acrylate, ethyl acrylate, butyl acrylate, isobutyl acrylate, t-butyl acrylate, 2-ethylhexyl acrylate, lauryl acrylate, and isobornyl acrylate; methacrylates such as methyl methacrylate, ethyl methacrylate, butyl methacrylate, isobutyl methacrylate, t-butyl methacrylate, 2-ethylhexyl methacrylate, lauryl methacrylate, and isobornyl methacrylate; fumarates such as monoethyl fumarate; and styrene.

The carboxy group of the alkali-soluble polymer may be introduced after the main chain is formed. The carboxy group of the alkali-soluble polymer may be introduced, for example, by reacting an unsaturated monocarboxylic acid with a compound having an epoxy group at the side chain and having the above-described polymer chain, and then further reacting a saturated or unsaturated polyvalent carboxylic anhydride.

The alkali-soluble polymer may have an unsaturated bond. The unsaturated bond of the alkali-soluble polymer may be introduced, for example, by adding, to a carboxy group at the side chain, a monomer that can react with the carboxy group and has a polymerizable functional group (typically, an epoxy group).

The weight-average molecular weight (Mw) of the alkali-soluble polymer may be 5,000 or more and 50,000 or less (i.e., from 5,000 to 50,000). The acid value of the alkali-soluble polymer may be 30 or more and 150 or less (i.e., from 30 to 150).

The photosensitive monomer reacts with the photopolymerization initiator to generate monomer radicals. The monomer radicals polymerize to form a polymer. The content of the photosensitive monomer is preferably 10 wt % or more and more preferably 20 wt % or more relative to the photosensitive organic component 22. The content of the photosensitive monomer is preferably 50 wt % or less and more preferably 40 wt % or less relative to the photosensitive organic component 22.

The photosensitive monomer is not limited as long as the photosensitive monomer has at least one reactive group causing a radical reaction. Examples of the reactive group causing a radical reaction include at least one selected from the group consisting of an acrylamide group, an acryloyl group, a methacryloyl group, an allyl group, a vinyl group, a styryl group, and a mercapto group. The photosensitive monomer may have at least one (meth)acryloyl group as a reactive group causing a radical reaction. The “(meth)acryloyl group” represents an acryloyl group and/or a methacryloyl group.

Examples of the photosensitive monomer having a (meth)acryloyl group include monofunctional (meth)acrylate monomers such as stearyl (meth)acrylate, tetrahydrofurfuryl (meth)acrylate, lauryl (meth)acrylate, 2-phenoxyethyl (meth)acrylate, isodecyl (meth)acrylate, isooctyl (meth)acrylate, tridecyl (meth)acrylate, caprolactone (meth)acrylate, and ethoxylated nonylphenol (meth)acrylate; difunctional (meth)acrylate monomers such as tripropylene glycol di(meth)acrylate, isocyanuric acid EO-modified diacrylate, 1,3-butanediol di(meth)acrylate, 1,4-butanediol di(meth)acrylate, diethylene glycol di(meth)acrylate, tetraethylene glycol di(meth)acrylate, triethylene glycol di(meth)acrylate, ethoxylated bisphenol-A di(meth)acrylate, and propoxylated neopentyl glycol di(meth)acrylate; trifunctional (meth)acrylate monomers such as glycerin tri(meth)acrylate, trimethylolpropane tri(meth)acrylate, ethoxylated trimethylolpropane tri(meth)acrylate, propoxylated trimethylolpropane tri(meth)acrylate, propoxylated glyceryl tri(meth)acrylate, pentaerythritol tri(meth)acrylate, dipentaerythritol tri(meth)acrylate, ethoxylated pentaerythritol tri(meth)acrylate, tris(2-hydroxyethyl) isocyanurate tri(meth)acrylate, caprolactone-modified tris(2-hydroxyethyl) isocyanurate tri(meth)acrylate, hexanediol tri(meth)acrylate, tripropylene glycol tri(meth)acrylate, trimethylolpropane tri(meth)acrylate, and EO-modified trimethylolpropane tri(meth)acrylate; tetrafunctional (meth)acrylate monomers such as pentaerythritol tetra(meth)acrylate, dipentaerythritol tetra(meth)acrylate, tripentaerythritol tetra(meth)acrylate, ditrimethylolpropane tetra(meth)acrylate, and ethoxylated pentaerythritol tetra(meth)acrylate; pentafunctional (meth)acrylate monomers such as dipentaerythritol penta(meth)acrylate, tripentaerythritol penta(meth)acrylate, and dipentaerythritol monohydroxypenta(meth)acrylate; hexafunctional (meth)acrylate monomers such as dipentaerythritol hexa(meth)acrylate, caprolactone-modified dipentaerythritol hexa(meth)acrylate, and tripentaerythritol hexa(meth)acrylate; hepta- or higher functional (meth)acrylate monomers such as tripentaerythritol hepta(meth)acrylate and tripentaerythritol octa(meth)acrylate.

The photosensitive monomer may be a tri- or higher functional (meth)acrylate monomer, may be a tetra- or higher functional (meth)acrylate monomer, or may be a penta-or higher functional (meth)acrylate monomer. The photosensitive monomer may be dipentaerythritol monohydroxypenta(meth)acrylate.

The photopolymerization initiator generates highly reactive radicals by active energy rays. The radicals add to the photosensitive monomer and cause an initiation reaction of the photosensitive monomer. The radicals are generated in a chain reaction, and shortly a polymer derived from the photosensitive monomer is generated. The content of the photopolymerization initiator is preferably 0.5 wt % or more and more preferably 1.0 wt % or more relative to the photosensitive organic component 22. The content of the photopolymerization initiator is preferably 10 wt % or less and more preferably 5.0 wt % or less relative to the photosensitive organic component 22.

Examples of the photopolymerization initiator include at least one selected from the group consisting of benzoin or benzoin ether compounds, alkylphenone compounds, benzophenone compounds, oxime ester compounds, acylphosphine oxide compounds, and α-ketoester compounds.

Examples of the benzoin or benzoin ether photopolymerization initiator include benzoin, benzoin ethyl ether, benzoin isopropyl ether, benzoin phenyl ether, methylbenzoin, ethylbenzoin, and benzyldimethylketal.

Examples of the alkylphenone photopolymerization initiator include α-hydroxyalkylphenone compounds and α-aminoalkylphenone compounds.

Specific examples of the α-aminoalkylphenone compounds include 2-methyl-1-(4-methylthiophenyl)-2-morpholinopropan-1-one, 2-benzyl-2-dimethylamino-1-(4-morpholinophenyl)-butanone-1, 2-(dimethylamino)-2-[(4-methylphenyl)methyl]-1-[4-(4-morpholinyl)phenyl]-1-butanone, and 2-methyl-2-morpholino(4-thiomethylphenyl)propan-1-one.

Specific examples of the α-hydroxyalkylphenone compounds include 2-hydroxy-2-methylpropiophenone, diethoxyacetophenone, 4-(2-hydroxyethoxy)phenyl-(2-hydroxy-2-propyl) ketone, 2-hydroxy-2-methyl-1-phenyl-propan-1-one, 1-hydroxy-cyclohexyl-phenyl ketone, 2,2-dimethoxy-1,2-diphenylethan-1-one, 2-hydroxy-2-methyl-1-phenylpropan-1-one, 1-(4-dodecylphenyl)-2-hydroxy-2-methylpropan-1-one, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methylpropan-1-one, 1,1′-(oxybis(4,1-phenylene))bis(2-hydroxy)-2-methylpropan-1-one, 2,2-dimethoxy-2-phenylacetophenone, oligo{2-hydroxy-2-methyl-1-[4-(1-methylvinyl)phenyl]propane}, and 4-(2-acryloyl-oxyethoxy)phenyl-2-hydroxy-2-propyl ketone.

Examples of the benzophenone photopolymerization initiator include benzophenone, methylbenzophenone, benzoylbenzoic acid, methyl o-benzoylbenzoate, 2-n-butoxy-4-dimethylaminobenzoate, 2-dimethylaminoethyl benzoate, ethyl p-dimethylaminobenzoate, isoamyl p-dimethylaminobenzoate, 4-phenylbenzophenone, 4,4′-bis(diethylamino)benzophenone, 3,3′-dimethyl-4-methoxybenzophenone, (1-[4-(4-benzoylphenylsulfanyl)phenyl]-2-methyl-2-(4-methylphenylsulfonyl)propan-1-one, 4-(4-methylphenylthio)benzophenone, methyl-o-benzoylbenzoate, 4,4′-dichlorobenzophenone, hydroxybenzophenone, 4-benzoyl-4′-methyl-diphenyl sulfide, acrylated benzophenone, 3,3′,4,4′-tetra(t-butylperoxycarbonyl)benzophenone, and 3,3′-dimethyl-4-methoxybenzophenone; thioxanthone compounds such as 2-isopropylthioxanthone, 2,4-dimethylthioxanthone, 2-chlorothioxanthone, 2,4-diethylthioxanthone, 2,4-dimethylthioxanthone, 2,4-diisopropylthioxanthone, isopropylthioxanthone, and 2,4-dichlorothioxanthone; and Michler's ketone, 4,4′-bis(diethylamino)benzophenone, 3,3′,4,4′-tetra(t-butylperoxycarbonyl)benzophenone, and benzophenone derivative polymers.

Examples of the oxime ester photopolymerization initiator include 1,2-octanedione-1-[4-(phenylthio)phenyl]-2-(O-benzoyloxime), 1-phenyl-1,2-propanedione-2-(o-ethoxycarbonyl)oxime, and ethanone-1-[9-ethyl-6-(2-methylbenzoyl)-9H-carbazol-3-yl]-1-(O-acetyloxime).

Examples of the acylphosphine oxide photopolymerization initiator include 2,4,6-trimethylbenzoyl-diphenylphosphine oxide, bis(2,4,6-trimethylbenzoyl)phenylphosphine oxide, bis(2,6-dimethoxybenzoyl)-2,4,4-trimethylpentylphosphine oxide, and ethyl (2,4,6-trimethylbenzoyl)phenylphosphinate.

Examples of the α-ketoester photopolymerization initiator include methyl benzoylformate, 2-(2-oxo-2-phenylacetoxyethoxy)ethyl ester of oxyphenylacetic acid, and 2-(2-hydroxyethoxy)ethyl ester of oxyphenylacetic acid.

The photopolymerization initiator may be an alkylphenone compound, may be an α-aminoalkylphenone compound, and may be 2-methyl-1-(4-methylthiophenyl)-2-morpholinopropan-1-one.

Non-limiting examples of the solvent include ethylene glycol monobutyl ether, ethylene glycol monohexyl ether, ethylene glycol monoethylhexyl ether, propylene glycol monobutyl ether, dipropylene glycol monoethyl ether, dipropylene glycol monobutyl ether, propylene glycol monophenyl ether, ethyl acetate, butyl acetate, pentyl acetate, hexyl acetate, and cyclohexanol acetate. The content of the solvent is preferably 20 wt % or more and more preferably 30 wt % or more relative to the photosensitive organic component 22. The content of the solvent is preferably 60 wt % or less and more preferably 50 wt % or less relative to the photosensitive organic component 22. The photosensitive organic component 22 may further contain additives such as a sensitizer, an anti-foaming agent, and an anti-settling agent.

The dispersant is not particularly limited, and is, for example, a polycarboxylic acid-based polymer dispersant. The content of the dispersant is preferably 0.1 wt % or more and more preferably 0.2 wt % or more relative to the photosensitive conductive paste 20. The content of the dispersant is preferably 5.0 wt % or less and more preferably 1.0 wt % or less relative to the photosensitive conductive paste 20.

Since the photosensitive conductive paste 20 does not contain the commonly-used material, the amount of powdery components can be decreased as compared with known photosensitive conductive pastes, which can improve the resolution at the time of photolithographic patterning. Furthermore, since the conductive powder 21 is covered with the glass 23, the sintering of the conductive powder 21 is suppressed until the firing temperature reaches the glass softening point (Ts) of the glass 23. Therefore, the shrinkage percentage of the coil 5 (inner electrode) during firing can be reduced. As a result, interlayer peeling called delamination, which is a structural defect that may occur between the coil 5 and the body 4 during firing, can be suppressed. When the firing temperature exceeds the glass softening point (Ts), the sintering of the conductive powder 21 is promoted by liquid-phase sintering. Therefore, the electrical resistance of the coil 5 after firing can be reduced as compared with the related art.

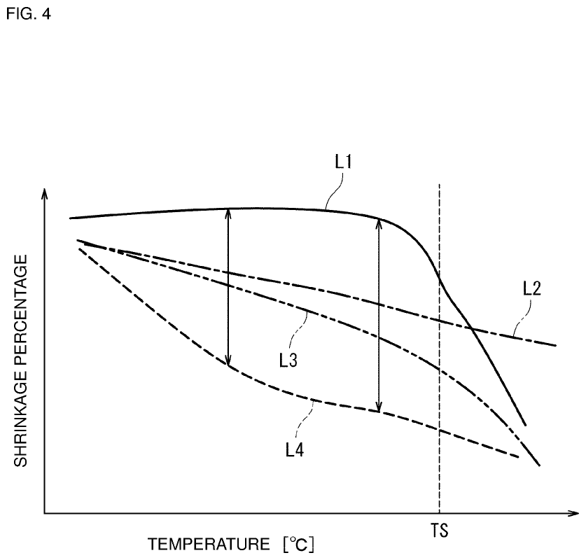

FIG. 4 is a diagram for describing effects of suppressing delamination and reducing the electrical resistance of the inner electrode. In FIG. 4, L1 indicates the relationship between the firing temperature and the shrinkage percentage for the body 4. L2 indicates the relationship between the firing temperature and the shrinkage percentage for an inner electrode using a known photosensitive conductive paste to which the commonly-used material has been added. L3 indicates the relationship between the firing temperature and the shrinkage percentage for the inner electrode using the photosensitive conductive paste according to the present disclosure. L4 indicates the relationship between the firing temperature and the shrinkage percentage for an inner electrode using a photosensitive conductive paste not covered with the glass 23.

As indicated by L3, in the present disclosure, the conductive powder 21 is covered with the glass 23 and thus the shrinkage of the inner electrode is suppressed until the firing temperature reaches the glass softening point (Ts) of the glass 23. Therefore, the difference between the shrinkage percentage of the body 4 and the shrinkage percentage of the inner electrode does not become excessively large, which can suppress the occurrence of delamination between the body 4 and the inner electrode. On the other hand, when the firing temperature exceeds the glass softening point (Ts) of the glass 23, the shrinkage of the inner electrode proceeds. That is, the sintering of the conductive powder 21 is promoted by liquid-phase sintering. As a result, the electrical resistance of the inner electrode is reduced as compared with the related art. When the firing temperature exceeds the glass softening point (Ts) of the glass 23, the shrinkage also proceeds in the body 4. This suppresses the occurrence of delamination even in this temperature range.

In contrast, as illustrated in L2, the commonly-used material is added in the related art and thus the shrinkage of the inner electrode during firing is suppressed. In the related art, however, the presence of the commonly-used material prevents the proceeding of the shrinkage of the inner electrode even when the firing temperature is increased to high temperatures, and prevents the proceeding of the sintering of the conductive powder. As a result, the electrical resistance of the inner electrode is not sufficiently reduced. Furthermore, as indicated by L4, when the conductive powder 21 is not covered with the glass 23, the shrinkage of the inner electrode considerably proceeds immediately after the start of firing, and the difference between the shrinkage percentage of the body 4 and the shrinkage percentage of the inner electrode becomes excessively large. As a result, delamination may occur between the body 4 and the inner electrode.

Preferably, the refractive index of the glass 23 is 1.60 or less. In this case, the refractive index of the glass 23 and the refractive index of the photosensitive organic component 22 can be brought close to each other. This can suppress the scattering of light at the time of photolithographic patterning of the photosensitive conductive paste 20 and can further improve the resolution at the time of photolithographic patterning.

Preferably, the glass softening point (Ts) of the glass 23 is 650° C. or higher and 800° C. or lower (i.e., from 650° C. to 800° C.). In this case, it is possible to further reduce the shrinkage percentage of the coil 5 during firing while reducing the electrical resistance of the coil 5.

### Preferably, the Glass 23 Contains

SiO₂: 15 mass % or more and 90 mass % or less (i.e., from 15 mass % to 90 mass %),
B₂O₃: 10 mass % or more and 50 mass % or less (i.e., from 10 mass % to 50 mass %),
Al₂O₃: 3 mass % or more and 15 mass % or less (i.e., from 3 mass % to 15 mass %),
KF: 10 mass % or more and 30 mass % or less (i.e., from 10 mass % to 30 mass %), and

at least one selected from the group consisting of Li₂O, Na₂O, and K₂O: 2 mass % or more and 20 mass % or less (i.e., from 2 mass % to 20 mass %). In this case, it is possible to further reduce the shrinkage percentage of the coil 5 during firing while reducing the electrical resistance of the coil 5. Furthermore, it is possible to further improve the resolution at the time of photolithographic patterning.

Preferably, the glass softening point (Ts) of the glass 23 is 550° C. or higher, and the refractive index of the glass 23 is 1.60 or less. In this case, it is possible to further reduce the shrinkage percentage of the coil 5 during firing while reducing the electrical resistance of the coil 5. Furthermore, it is possible to further improve the resolution at the time of photolithographic patterning.

Preferably, the multilayer electronic component 10 includes a body 4 containing borosilicate glass and an inorganic filler and a coil 5 that is disposed in the body 4 and that is a sintered body of the photosensitive conductive paste 20. In this case, it is possible to obtain a multilayer electronic component 10 which includes the coil 5 having a desired shape and a low electrical resistance and in which the formation of structural defects that may occur because of the shrinkage of the coil 5 during firing is suppressed.

Preferably, the coil 5 encloses the glass 23, and

### The Glass 23 Contains

SiO₂: 15 mass % or more and 90 mass % or less (i.e., from 15 mass % to 90 mass %),
B₂O₃: 10 mass % or more and 50 mass % or less (i.e., from 10 mass % to 50 mass %),
Al₂O₃: 3 mass % or more and 15 mass % or less (i.e., from 3 mass % to 15 mass %),
KF: 10 mass % or more and 30 mass % or less (i.e., from 10 mass % to 30 mass %), and

at least one selected from the group consisting of Li₂O, Na₂O, and K₂O: 2 mass % or more and 20 mass % or less (i.e., from 2 mass % to 20 mass %). In this case, it is possible to obtain a multilayer electronic component 10 which includes the coil 5 having a desired shape and a lower electrical resistance and in which the formation of structural defects that may occur because of the shrinkage of the coil 5 during firing is further suppressed.

Method for producing multilayer electronic component

Next, a method for producing the multilayer electronic component 10 will be described. The method for producing the multilayer electronic component 10 includes a step of stacking a photosensitive conductive paste 20 on an insulating layer 40, and a step of sintering the photosensitive conductive paste 20 and the insulating layer 40 at a firing temperature equal to or higher than the glass softening point (Ts).

A coil 5 (inner electrode) is formed from the photosensitive conductive paste 20.

A body 4 is formed from the insulating layer 40.

The coil 5 is disposed in the body 4.

According to the production method described above, it is possible to improve the resolution at the time of photolithographic patterning while reducing the shrinkage percentage of the coil 5 during firing. Furthermore, the electrical resistance of the coil 5 after firing can be reduced.

Preferably, in the sintering step, the glass 23 is partly enclosed in the coil 5. In this case, the coefficient of linear expansion of the coil 5 and the coefficient of linear expansion of the body 4 can be brought close to each other.

Hereafter, an example of the method for producing the multilayer electronic component 10 using the photosensitive conductive paste 20 of the present disclosure will be specifically described.

As illustrated in FIG. 2, a photosensitive glass paste serving as a photosensitive insulating paste is applied by screen printing onto a support film such as a PET film and dried. Then, the entire surface is exposed. This is repeatedly performed several times to obtain an insulating layer (glass layer) 40 having a predetermined thickness (e.g., about 100 μm). In FIG. 2, the support film is omitted.

The photosensitive insulating paste such as a photosensitive glass paste contains insulating inorganic components and photosensitive organic components. The photosensitive glass paste contains, for example, a glass powder and a ceramic aggregate (inorganic filler) as insulating inorganic components, and contains, for example, an alkali-soluble polymer, a photosensitive monomer, and a photopolymerization initiator as photosensitive organic components. A solvent, an organic dye, an anti-foaming agent, and the like may also be contained as the photosensitive organic components.

The type of the glass powder contained in the photosensitive insulating paste is not particularly limited. For example, a SiO₂—B₂O₃—K₂O-based glass containing SiO₂, B₂O₃, and K₂O at a predetermined ratio can be used. Two or more glass powders may be mixed and used. The average particle diameter of the glass powder is not particularly limited, but is preferably 0.1 μm or more and 5.0 μm or less (i.e., from 0.1 μm to 5.0 μm).

The type of the ceramic aggregate contained in the photosensitive insulating paste is not particularly limited. For example, alumina can be used. Two or more ceramic aggregates may be mixed and used. The average particle diameter of the ceramic aggregate is not particularly limited, but is preferably 0.1 μm or more and 5.0 μm or less (i.e., from 0.1 μm to 5.0 μm).

The insulating layer 40 may be produced by stacking green sheets that have been formed into sheets in advance.

The photosensitive conductive paste of the present disclosure is applied by screen printing onto the insulating layer 40 so as to have a film thickness of about 5 μm or more and 10 μm or less (i.e., from 5 μm to 10 μm) and dried. Then, the photosensitive conductive paste is selectively exposed and developed to form a coil wiring line 2 of the first layer.

The photosensitive glass paste is applied by screen printing onto the entire surface so as to cover the coil wiring line 2 of the first layer and have a film thickness of about 15 μm, and dried. Subsequently, the photosensitive glass paste is selectively exposed and developed to form a via hole 3 at a predetermined position of the insulating layer 40 formed on the coil wiring line 2 of the first layer.

The photosensitive conductive paste of the present disclosure is again applied by screen printing onto the entire surface so as to have a film thickness of about 5 μm or more and 10 μm or less (i.e., from 5 μm to 10 μm), and dried. Then, the photosensitive conductive paste is selectively exposed and developed to form a coil wiring line 2 of the second layer.

The stacking of the insulating layer 40 and the coil wiring line 2 is repeatedly performed until a desired number of layers is obtained.

Furthermore, the application of the photosensitive glass paste onto the entire surface, the drying of the photosensitive glass paste, and the exposure of the photosensitive glass paste on the entire surface are repeatedly performed a required number of times to form an insulating layer 40 on an uppermost coil wiring line 2. As a result, a multilayer structure in which the coil wiring lines 2 are formed by interlayer connection through the via holes 3 is obtained.

The obtained multilayer structure is cut into chips using a dicer, and then the support film such as a PET film is separated. Then, firing is performed at a temperature equal to or higher than the glass softening point of the glass covering the conductive powder in the photosensitive conductive paste. As a result of this firing, the photosensitive conductive paste is sintered to form the coil 5. The insulating layer 40 is also sintered to form the body 4. By performing firing at a temperature equal to or higher than the glass softening point, the glass covering the conductive powder is partly discharged into the body, but the glass is partly enclosed in the coil 5.

A first outer electrode 6a and a second outer electrode 6b are formed on the fired multilayer body. Furthermore, a plating layer having a single-layer or multilayer structure may be deposited on the outer surfaces of the first outer electrode 6a and the second outer electrode 6b by, for example, an electrolytic plating method or an electroless plating method. Thus, the multilayer electronic component 10 illustrated in FIG. 1 is obtained.

Note that the present disclosure is not limited to the above-described embodiments, and design changes can be made without departing from the scope of the present disclosure.

### Examples

Although the present disclosure will be more specifically described based on Examples, the present disclosure is not limited to the following Examples. Appropriate modifications can be obviously made without departing from the gist described above and below. These modifications are also within the technical scope of the present disclosure.

### (1) Preparation of Photosensitive Conductive Paste

Raw materials were blended at a ratio shown in Table 1 and sufficiently mixed to obtain a photosensitive resin serving as a photosensitive organic component.

TABLE 1

| | Content in photo- |
|---|---|
| | sensitive resin |
| Component | (parts by weight) |
| Polymer (an acrylic polymer having a carboxy | 25 |
| group at a side chain) | |
| Monomer (trimethylolpropane tri(meth)acrylate) | 25 |
| Photopolymerization initiator (α-aminoalkylphenone) | 4 |
| Solvent (cyclohexanol acetate) | 45 |
| Anti-foaming agent | 1 |

A glass-covered conductive powder that was covered with a glass component and other components were blended at a ratio shown in Table 2. This was sufficiently mixed with a three-roll mill to obtain a photosensitive conductive paste for forming inner electrodes. The conductive powder used was an Ag powder having an average particle diameter D50 of 2.0 μm.

TABLE 2

| Component | Blending ratio (wt %) |
|---|---|
| Glass-covered conductive powder | 80 |
| Photosensitive organic component | 18 |
| Dispersant | 2 |
| Total | 100 |

Table 3 shows a list of glass materials used for covering the conductive powder. The glass component used for covering can be identified by elementary analysis of the powder, such as fluorescence spectroscopy, ICP, or SEM-WDX. The glass softening point of the identified glass component can be calculated from a temperature at which a glass frit sample having the same composition has a viscosity coefficient n=107 measured using a Littleton viscometer. Similarly, the refractive index of the glass can be measured from the glass frit sample using a minimum deviation method.

Examples of the method for covering the conductive powder with the glass include a sol-gel method, a spray coating method, a mechanofusion method, a chemical vapor deposition (CVD) method, and an atomic layer deposition (ALD) method. The glass-covered conductive powder obtained under the condition that a glass component layer having a desired thickness can be formed by each method can be used for the paste.

TABLE 3

| | Example | Example | Example | Example | Example | Example |
|---|---|---|---|---|---|---|
| | 1 | 2 | 3 | 4 | 5 | 6 |
| Glass | 790 | 718 | 715 | 657 | 562 | 490 |
| softening | | | | | | |
| point | | | | | | |
| (° C.) | | | | | | |
| Refractive | 1.47 | 1.59 | 1.49 | 1.46 | 1.52 | 1.99 |
| index | | | | | | |

For Comparative Examples, a known photosensitive conductive paste containing an Ag powder not covered with a glass and a known photosensitive conductive paste containing an Ag powder not covered with a glass and Al₂O₃ (commonly-used material) serving as a metal oxide were prepared.

### (2) Preparation of Sample for Evaluating Specific Resistance and Measurement

The photosensitive conductive paste prepared by the above-described method was applied by screen printing onto an alumina substrate so as to have a film thickness of 10 μm or more and 20 μm or less (i.e., from 10 μm to 20 μm) and dried. Then, exposure treatment was performed through a photomask having a wiring pattern, and development was performed with an alkaline aqueous solution to form a wiring pattern. The formed wiring pattern was fired at 900° C. to produce an electrode wiring line for resistance measurement. The resistance value, line width, line length, and film thickness of the obtained wiring sample were measured. The specific resistance value was calculated based on the Ag volume obtained by subtracting the volume of the glass from the calculated volume of the wiring line. A specific resistance value of 2.2 μΩ·cm or less was evaluated as good (pass). A specific resistance value of 1.9 μΩ·cm or less was evaluated as excellent (pass). A specific resistance value exceeding 2.2 μΩ·cm was evaluated as poor (fail).

### (3) Preparation of Sample for Evaluating Firing Shrinkage Percentage and Measurement

The photosensitive conductive paste prepared by the above-described method was applied onto a smooth substrate using a screen plate having a dot pattern and dried. The volume of the dot pattern of the obtained paste was calculated using a laser displacement meter. Such a dot pattern was then heat-treated at 500° C. and 700° C. The volume of the dot pattern of the sample subjected to the heat treatment at each temperature was calculated again using a laser displacement meter. Based on the volumes before and after the heat treatment, the percentage by which the volume was reduced after the heat treatment was calculated, and this value was defined as a firing shrinkage percentage.

In the case where the shrinkage percentage of the photosensitive conductive paste is large at 500° C. and 700° C., when the paste is used as an inner electrode of a multilayer coil component, the deviation from the shrinkage behavior of a material for the body is large, which is likely to cause delamination. Therefore, the shrinkage percentage at each temperature is preferably smaller.

A level at which the shrinkage percentage at 500° C. was less than 20% was defined as excellent (pass). A level at which the shrinkage percentage was 20% or more and less than 30% (i.e., from 20% to less than 30%) was defined as good (pass). A level at which the shrinkage percentage was 30% or more was defined as poor (fail).

A level at which the shrinkage percentage at 700° C. was less than 30% was defined as excellent (pass). A level at which the shrinkage percentage was 30% or more and less than 40% (i.e., from 30% to less than 40%) was defined as good (pass). A level at which the shrinkage percentage was 40% or more was defined as poor (fail).

### (4) Evaluation of Resolution

A photosensitive conductive paste was applied by screen printing onto an alumina substrate and then dried at 60° C. for 30 minutes to form a photosensitive conductive paste film having a film thickness of 10 μm. Subsequently, the photosensitive conductive paste film was subjected to mask exposure treatment by irradiating the substrate with light beams from an ultra-high pressure mercury lamp (manufactured by Ushio Inc.) through a photomask having a linear pattern of L/S=25/25 μm under the condition of 1000 mJ/cm² (405 nm). Thereafter, development treatment was performed with an aqueous triethanolamine solution.

### (4-1) Patternability

When patterning was performed without residues and line skips, “good (pass)” was given. When patterning was performed with line skips, “poor (fail)” was given.

### (4-2) Line Thickening Amount

When a value obtained by measuring the line width of the patterned wiring line with a confocal microscope (Optelics, manufactured by Lasertec Corporation) was set as X, the line thickening amount was calculated from line thickening amount=X−25. The line thickening amount is preferably as small as possible because wiring dimensions close to the opening width of the photomask are achieved. In this specification, formation of a desired shape with high accuracy by the photolithography method described above is referred to as excellent resolution in some cases.

Table 4 shows the measurement results. In contrast to Comparative Examples, it was found in Examples in which the conductive powder covered with the glass was used that the shrinkage of the electrode during firing could be slowed down because of the sintering suppressing effect of Ag up to the temperature at which the glass was sufficiently softened. It was also found that the electrode resistance after firing could be reduced as compared with a composition containing a commonly-used material such as a metal oxide because of the sintering promoting effect (liquid-phase sintering) of the conductive powder after the start of glass softening. It was also found in Examples that the photolithographic patternability could be improved because the specific surface area of the Ag powder and the amount of powdery components did not increase. For the features of the glass component used for covering, it was found that the glass softening point Ts was favorably in the range of 600° C. or higher and lower than 800° C. (i.e., from 600° C. to 800° C.) in terms of the firing shrinkage percentage and the specific resistance, and the refractive index was as small as possible and more preferably in the range of 1.60 or less from the viewpoint of the line thickening amount at the time of photolithography. It was found that when the photosensitive conductive paste of the present disclosure was applied to inner electrodes for electronic components, high wiring formation precision, low specific resistance, and suppression of delamination after firing could be achieved in a balanced manner.

Specifically, in Examples 1 to 6 in which the photosensitive conductive paste containing the conductive powder covered with the glass was used, it was found that the firing shrinkage percentage was small and the delamination could be suppressed at both firing temperatures of 500° C. and 700° C. In Examples 1 to 6, it was found that the resolution at the time of photolithographic patterning could be improved because the specific resistance after firing was small, and both the patternability and the line thickening amount were good. In particular, in Examples 1 to 4 in which the glass softening point Ts was 650° C. or higher and 800° C. or lower (i.e., from 650° C. to 800° C.), it was found that the occurrence of delamination could be further suppressed because the shrinkage could be further suppressed even at a firing temperature of 700° C. while the specific resistance after firing was reduced. In Examples 1 to 5 in which the refractive index of the glass was 1.60 or less, it was found that the resolution at the time of photolithographic patterning could be further improved because the line thickening amount was 12 μm or less.

In contrast, in Comparative Example 1, the specific resistance after firing was good, but the firing shrinkage percentage was large at both firing temperatures of 500° C. and 700° C. because the conductive powder was not covered with the glass. In Comparative Example 2, the firing shrinkage percentage was small at both firing temperatures of 500° C. and 700° C. because of the presence of the commonly-used material. However, the specific resistance was large, and the patternability was poor.

TABLE 4

| | Glass | | Firing | Firing | Specific | | Line |
|---|---|---|---|---|---|---|---|
| | softening | | shrinkage | shrinkage | resistance | | thickening |
| | point | Refractive | percentage | percentage | at 900° C./ | | amount |
| Level | (° C.) | index | at 500° C. | at 700° C. | 60 min | Patternability | (μm) |
| Example 1 | 790 | 1.47 | Excellent | Excellent | Excellent | Good | 8 |
| Example 2 | 718 | 1.59 | Excellent | Excellent | Excellent | Good | 12 |
| Example 3 | 715 | 1.49 | Excellent | Excellent | Excellent | Good | 8 |
| Example 4 | 657 | 1.46 | Excellent | Excellent | Excellent | Good | 7 |
| Example 5 | 562 | 1.52 | Excellent | Good | Excellent | Good | 10 |
| Example 6 | 490 | 1.99 | Excellent | Good | Excellent | Good | 16 |
| Comparative | Not | — | Poor | Poor | Good | Good | 11 |
| Example 1 | covered | | | | | | |
| | with | | | | | | |
| | glass | | | | | | |
| Comparative | Addition | — | Excellent | Excellent | Poor | Poor | — |
| Example 2 | of metal | | | | | | |
| | oxide | | | | | | |
| | (Al₂O₃) | | | | | | |

<1> A photosensitive conductive paste comprising a conductive powder, an alkali-soluble polymer; a photosensitive monomer; a photopolymerization initiator; a dispersant; and a solvent. The conductive powder is covered with a glass having a glass softening point (Ts) of 800° C. or lower.
<2> The photosensitive conductive paste according to <1>, wherein the glass has a refractive index of 1.60 or less.
<3> The photosensitive conductive paste according to <1> or <2>, wherein the glass softening point (Ts) is 650° C. or higher and 800° C. or lower (i.e., from 650° C. to 800° C.).
<4> The photosensitive conductive paste according to <1> or <2>, wherein the glass softening point (Ts) is 550° C. or higher, and the glass has a refractive index of 1.60 or less.
<5> The photosensitive conductive paste according to any one of <1> to <4>, wherein the conductive powder is an atomized Ag powder.
<6> The photosensitive conductive paste according to <5>, wherein the atomized Ag powder has an average particle diameter D50 of 1.0 μm or more and 5.0 μm or less (i.e., from 1.0 μm to 5.0 μm).
<7> A method for producing a multilayer electronic component, comprising a step of stacking the photosensitive conductive paste according to any one of <1> to <6> on an insulating layer; and a step of sintering the photosensitive conductive paste and the insulating layer at a firing temperature equal to or higher than the glass softening point (Ts). An inner electrode is formed from the photosensitive conductive paste, a body is formed from the insulating layer, and the inner electrode is disposed in the body.
<8> The method for producing a multilayer electronic component according to <7>, wherein in the sintering step, the glass is partly enclosed in the inner electrode.
<9> A multilayer electronic component comprising a body containing borosilicate glass and an inorganic filler; and an inner electrode disposed in the body, the inner electrode being a sintered body of the photosensitive conductive paste according to any one of <1> to <6>.
<10> The multilayer electronic component according to <9>, wherein the inner electrode encloses the glass, and the glass contains SiO₂: 15 mass % or more and 90 mass % or less (i.e., from 15 mass % to 90 mass %), B₂O₃: 10 mass % or more and 50 mass % or less (i.e., from 10 mass % to 50 mass %), Al₂O₃: 3 mass % or more and 15 mass % or less (i.e., from 3 mass % to 15 mass %), KF: 10 mass % or more and 30 mass % or less (i.e., from 10 mass % to 30 mass %), and at least one selected from the group consisting of Li₂O, Na₂O, and K₂O: 2 mass % or more and 20 mass % or less (i.e., from 2 mass % to 20 mass %).

What is claimed is:

1. A photosensitive conductive paste comprising:
a conductive powder;
an alkali-soluble polymer;
a photosensitive monomer;
a photopolymerization initiator;
a dispersant; and
a solvent,
wherein the conductive powder is covered with a glass having a glass softening point of 800° C. or lower.

2. The photosensitive conductive paste according to claim 1, wherein
the glass has a refractive index of 1.60 or less.

3. The photosensitive conductive paste according to claim 1, wherein
the glass softening point is from 650° C. to 800° C.

4. The photosensitive conductive paste according to claim 1,
wherein the glass softening point is 550° C. or higher, and
the glass has a refractive index of 1.60 or less.

5. The photosensitive conductive paste according to claim 1, wherein
the conductive powder is an atomized Ag powder.

6. The photosensitive conductive paste according to claim 5, wherein
the atomized Ag powder has an average particle diameter D50 of from 1.0 μm to 5.0 μm.

7. A method for producing a multilayer electronic component, comprising:
applying and stacking the photosensitive conductive paste according to claim 1 on insulating layers; and
sintering the photosensitive conductive paste and the insulating layers at a firing temperature equal to or higher than the glass softening point, obtaining an inner electrode from the photosensitive conductive paste, a body from the insulating layers, and disposing the inner electrode in the body.

8. The method for producing a multilayer electronic component according to claim 7, wherein
in the sintering, a part of the glass is enclosed in the inner electrode.

9. A multilayer electronic component comprising:
a body including borosilicate glass and an inorganic filler; and
an inner electrode disposed in the body, the inner electrode being a sintered body of the photosensitive conductive paste according to claim 1.

10. The multilayer electronic component according to claim 9,
wherein the inner electrode encloses the glass, and
the glass comprises
SiO₂: from 15 mass % to 90 mass %,
B₂O₃: from 10 mass % to 50 mass %,
Al₂O₃: from 3 mass % to 15 mass %,
KF: from 10 mass % to 30 mass %, and
at least one selected from the group consisting of Li₂O, Na₂O, and K₂O: from 2 mass % to 20 mass %.

11. The photosensitive conductive paste according to claim 2, wherein
the glass softening point is from 650° C. to 800° C.

12. The photosensitive conductive paste according to claim 2, wherein
the conductive powder is an atomized Ag powder.

13. A method for producing a multilayer electronic component, comprising:
applying and stacking the photosensitive conductive paste according to claim 1 on insulating layers; and
sintering the photosensitive conductive paste and the insulating layers at a firing temperature equal to or higher than the glass softening point, obtaining an inner electrode from the photosensitive conductive paste, a body from the insulating layers, and disposing the inner electrode in the body.

14. The method for producing a multilayer electronic component according to claim 13, wherein
in the sintering, a part of the glass is enclosed in the inner electrode.

15. A multilayer electronic component comprising:
a body including borosilicate glass and an inorganic filler; and
an inner electrode disposed in the body, the inner electrode being a sintered body of the photosensitive conductive paste according to claim 2.

16. The multilayer electronic component according to claim 15, wherein
the inner electrode encloses the glass, and
the glass comprises
SiO₂: from 15 mass % to 90 mass %,
B₂O₃: from 10 mass % to 50 mass %,
Al₂O₃: from 3 mass % to 15 mass %,
KF: from 10 mass % to 30 mass %, and
at least one selected from the group consisting of Li₂O, Na₂O, and K₂O: from 2 mass % to 20 mass %.
